(19) United States
(12) Patent Application Publication
(10) Pub. No.: US 2005/0149746 A1
(43) Pub. Date: Jul. 7, 2005

(54) SYSTEM FOR ACTIVELY UPDATING A CRYPTOGRAPHY MODULE IN A SECURITY GATEWAY AND RELATED METHOD

(76) Inventors: Chih-Chung Lu, Taipei City (TW); Hong-Wei Tzeng, Yun-Lin County (TW)

Correspondence Address: NORTH AMERICA INTERNATIONAL PATENT OFFICE (NAIPC), P.O. BOX 506, MERRIFIELD, VA, 22116, US

(21) Appl. No.: 10/709,635

(22) Filed: May 19, 2004

(30) Foreign Application Priority Data
Dec. 30, 2003 (TW) 092137361

(51) Int. Cl. H04L 9/32; G06F 11/30

(52) U.S. Cl. 713/191; 713/200; 713/164

(57) ABSTRACT

A system for actively updating a cryptography module in a security gateway and related method is used in a security gateway, such as a VPN gateway according to an IPSEC protocol, which is connected between at least one user computer system and a network system. The system includes a Web GUI, a module update unit, a defined module unit, and an extended library. A user can easily update or add decryption/encryption modules into the extended library of the gateway through the Web GUI and the module update unit instead of updating the decryption/encryption modules along with the entire kernel firmware. This can reduce the setting time, increase the efficiency of operation, reduce the maintenance cost, and promote the expansion of decryption/encryption modules of the gateway so that network transmission can become much safer.

### BACKGROUND OF INVENTION

1. Field of the Invention

The present invention relates to a system for updating a cryptography module and related method, and more particularly, to a system which can actively update a cryptography module in a security gateway and related method.

2. Description of the Prior Art

The most popular security gateway in the today's market is the Virtual Private Network Gateway (VPN Gateway). Virtual Private Networks allow users to login to a public network, such as the Internet or an Asynchronous Transfer Mode (ATM) Network, from any terminal in the world. The environment of a Virtual Private Network is the same as the environment of a local network, such as intranet or extranet. Therefore, Virtual Private Networks can offer the convenience of a public network and the safety of an internal network. Due to these advantages, authorized users can set up exclusive communications with other users, companies, branches, and customers by the Internet to transmit important information to each other. As shown in FIG. 1, the structure of a Virtual Private Network includes several user computer systems 10, 30, and 40 respectively having VPN gateways 104, 304, and 404, and setting up VPN tunnels 602 via the Internet 50 to transmit important information between each other. When a user uses one of the user computer systems 10, 30, or 40 to login to the internal computer system, such as a server 20, the computer systems 10, 30, or 40 can set up a VPN tunnel 602 by the respective VPN gateway 104, 304, or 404 for remote data access.

The technique of tunneling mentioned above involves using one of the three common communication protocols IPSEC, PPTP, and L2TP. In a public network, such as the Internet, a safe tunnel, the same as the one used in internal networks, is set up to protect packets of confidential information by encapsulation. This can prevent transmitted confidential information from being stolen by hackers. Also, transmission of confidential information can be for other systems such as security qualification, ID authentication, and decryption/encryption. This makes VPN gateways safe and diverse.

Decryption/encryption in VPNs mentioned above is of two types: symmetric secret key cryptography and asymmetric public key cryptography. For example, in the IPSEC protocol, using an Internet Key Exchange (IKE) protocol having IKE phase 1 and phase 2 generates a public key to protect a secret key transmitted to the receiver so that the receiver can use the secret key to open the encrypted information. The purpose of IKE is to set up, identify, and exchange a security association (SA) for the identification of the transmitter and the receiver; establishing the decryption/encryption algorithm; and generating, exchanging, and setting up the key. The key length of the VPN, the decryption/encryption algorithm, and the decryption/encryption executing functions are recorded in a decryption/encryption module in each VPN gateway.

Although most manufacturers of VPN gateways provide their own designs with standard decryption/encryption as the decryption/encryption according to the IPSEC protocol mentioned above, when considering the safety, stability, efficiency of execution, and communication through the entire system, the update of the decryption/encryption module is combined with the update of the kernel firmware of the VPN gateway. That is to say, when the decryption/encryption module needs to be updated, the kernel firmware must be updated at the same time. The prior art update is shown in FIG. 3. First, in step S200, a user computer system (such as the user computer system 10 in FIG. 1) is connected to a server (such as the server 20 in FIG. 1) through a browser and the Internet. Then, in step S210, a new kernel firmware is loaded into the storage device of the user computer system (storage device 102 in FIG. 1). In steps 220 and 230, the new kernel firmware is uploaded to a VPN gateway 104″ via a Web GUI 114 shown in FIG. 2. In step 240, a kernel update module 126 of a current library 124 of the VPN gateway 104 (FIG. 2) is used to start updating a kernel 134 with the new kernel firmware. Subsequently, in step 250, the kernel update module 126 updates the kernel firmware, including updating an decryption/encryption module 128 of the current library 124. Finally, in step 260, the VPN gateway is rebooted to achieve step 270, completing the update of the new decryption/encryption module.

The prior art has the following drawbacks:

(1) Although each decryption/encryption module only occupies a part of program code in the VPN gateway, the safety of the decryption/encryption module is very important. However, the decryption/encryption module provided by each manufacturer cannot satisfy all the requirements of users. In the prior art, when VPN gateways are made, the original configuration setting permanently stores the decryption/encryption module in the current library of the VPN gateway. When users want to use other kinds of decryption/encryption modules, they have to update the entire kernel firmware of the machine. Therefore, manufacturers must provide many versions of kernel firmware decryption/encryption modules to meet these requirements. Time is expended to load the kernel firmware, reducing the efficiency and introducing room for error. In addition, the costs of maintaining the different versions can be quite significant.

(2) The prior art lacks a necessary function. That is, users of VPN gateways should be allowed to develop and set up decryption/encryption modules according to their requirements instead of using the standard module provided by manufacturers. If VPN gateway products can provide the function of allowing users to update or add decryption/encryption modules by themselves, such flexible design would increase potential customers and promote the expansion of decryption/encryption modules in VPN gateways.

### SUMMARY OF INVENTION

It is therefore a primary objective of the claimed invention to provide a system for actively updating a cryptography module in a security gateway and related method. The claimed invention allows a user of the gateway to update the decryption/encryption modules of the extended library of the gateway through a module update unit instead of updating the decryption/encryption modules along with the entire kernel firmware. This can reduce the expended time, increase the efficiency of operation, and reduce the maintenance cost.

It is another objective of the claimed invention to provide a system for actively updating a cryptography module in a security gateway and related method. The claimed invention allows the user of the gateway to easily define the decryption/encryption modules and add the newly defined decryption/encryption modules into an extended library through a defined module unit and a module update unit. This can simplify the update and promote the expansion of decryption/encryption modules of gateways so that network transmission is much safer.

It is another objective of the claimed invention to provide a system for actively updating a cryptography module in a security gateway and related method. The claimed invention allows the user of the gateway to easily select a decryption/encryption module in a window through a Web GUI for adding the new or updated decryption/encryption module into the extended library. This can increase the efficiency of system operation and the convenience of operation.

In order to achieve the objectives mentioned above, the system for actively updating a cryptography module in a security gateway of the present invention is set in a security gateway, such as the VPN gateway according to IPSEC, which includes a current library, a kernel, and a daemon, and is connected between at least one user computer system and a network system.

The system for actively updating a cryptography module in a security gateway of the present invention comprises a Web GUI, a module update unit, a defined module unit, an extended library, an extended library interface, and a configuration set unit. The Web GUI can generate at least one window in the user computer system, the window having a decryption/encryption module update system to allow the user to selectively upload a new decryption/encryption module into the security gateway through the window. The module update unit is set in the current library to actively update a corresponding decryption/encryption module in the extended library according to the new decryption/encryption module uploaded to the security gateway or to add the new uploaded decryption/encryption module into the extended library. The extended library is used to accommodate decryption/encryption modules mentioned above. The extended library interface assists the extended library to communicate with the current library and the kernel. The configuration set unit is a system file for setting the execution process according to an IPSEC protocol. When a decryption/encryption module is updated or increased, the key exchange process is also updated.

The method of actively updating a cryptography module in a security gateway of the present invention is used in a security gateway. The security gateway is connected between at least one user computer system and a network system. The method includes: using the browser of the user computer system through the network system connection to the website of a gateway manufacturer to download a new decryption/encryption module program code into the user computer system; rebooting a Web GUI of the security gateway to generate at least one window in the user computer system, the window having a decryption/encryption module update system; selecting an uploaded decryption/encryption module, such as a defined decryption/encryption module, from the window provided by the Web GUI; uploading the selected decryption/encryption module to the security gateway, a module update unit actively updating a corresponding decryption/encryption module in an extended library according to the uploaded decryption/encryption module or adding the new decryption/encryption module into the extended library; updating the key exchange process of the security gateway according to an IKE protocol; and rebooting the security gateway to execute the new key exchange process.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a security gateway applied in the structure of a network system.

FIG. 2 is a diagram of a security gateway having decryption/encryption modules according to the prior art.

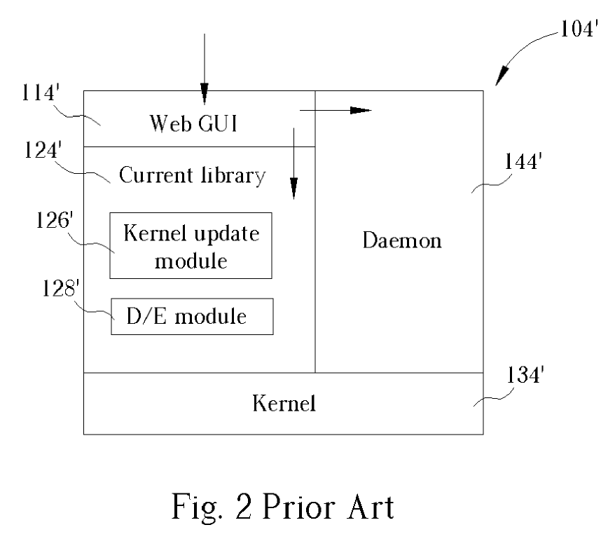

FIG. 3 is a flowchart of updating decryption/encryption modules of the security gateway in FIG. 2.

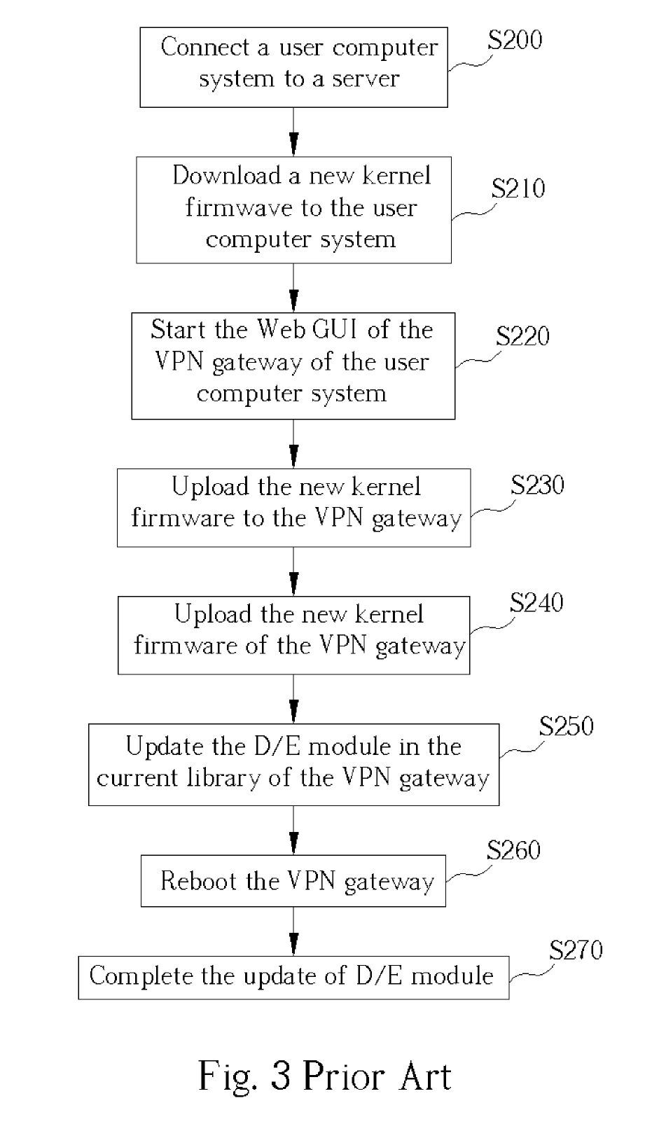

FIG. 4 is a diagram of a present invention system for actively updating a cryptography module in a security gateway.

FIG. 5 is a flowchart of updating decryption/encryption modules of the security gateway according to the present invention.

FIG. 6 is a flowchart of a key exchange process of the present invention according to an IKE protocol.

### DETAILED DESCRIPTION

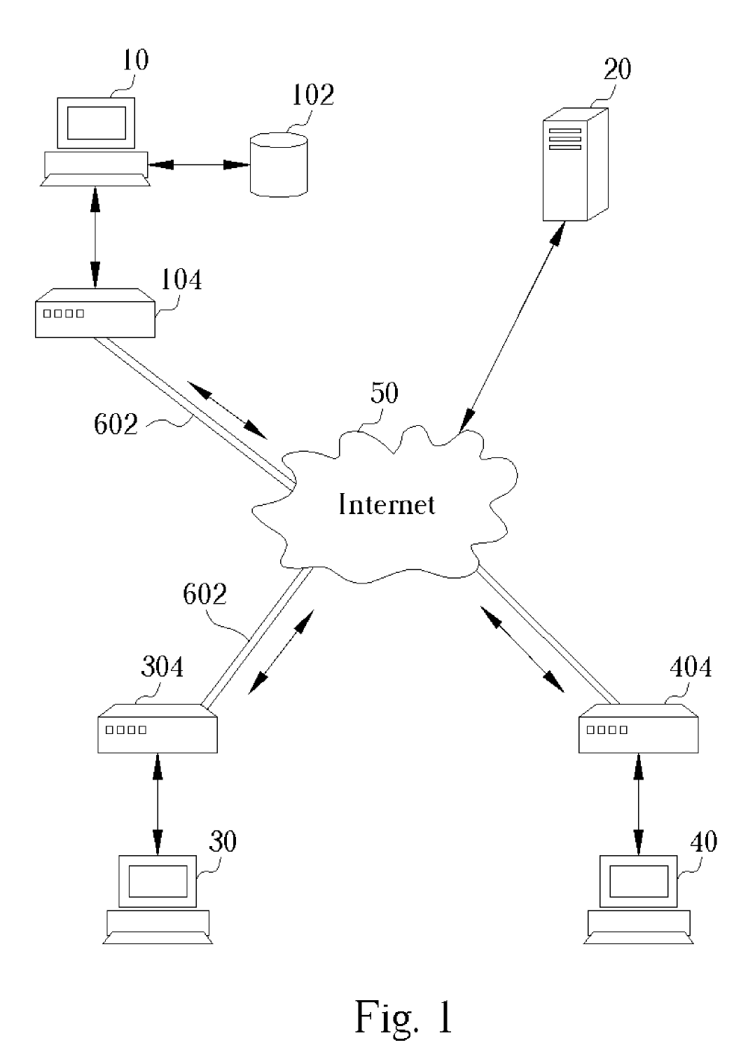

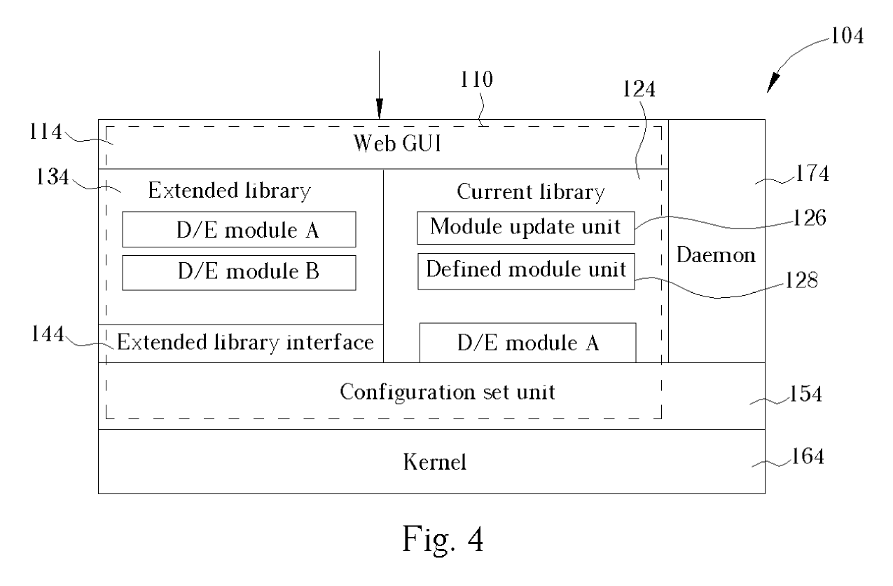

Please refer to FIG. 4. FIG. 4 shows a system 110 of actively updating a cryptography module in a security gateway according to the present invention. The system 110 is set in a network security gateway 104 as shown in FIG. 1. The network security gateway 104 is a VPN gateway connected to the Internet 50, the VPN gateway complying with an IPSEC protocol for allowing a user computer system 10 to set up a VPN tunnel 602 to securely transmit confidential information to other user computer systems 30 and 40. Additionally, the security gateway 104 includes a current library 124 having a default decryption/encryption module A, a kernel 164 being the operating system of the security gateway 104, and a daemon 174 for sequentially arranging processes of the entire gateway such as storing information, transmitting information, updating decryption/encryption modules, etc.

The system 110 includes a Web GUI, a module update unit 126, a defined module unit 128, an extended library 134, an extended library interface 144, and a configuration set unit 154. The extended library interface 144 generates at least one window having a plurality of decryption/encryption module update systems in the user computer system 10 to allow the user to easily operate or set the security gateway 104. Suppose that a system is to update a corresponding decryption/encryption module in the security gateway 104. Another system (defined as the decryption/encryption module system) allows the user to add and store an extra defined decryption/encryption module into the security gateway 104. Of course, before the user starts the Web GUI 114 for updating the decryption/encryption modules of the security gateway 104, the connection is necessarily established from the Internet to the website of the gateway manufacturer. However, a key difference is that only downloading a new decryption/encryption program code module to the user computer system is required, instead of downloading the entire kernel firmware.

The module update unit 126 is set in the current library 124 of the security gateway 104 and actively updates or adds the decryption/encryption module into the extended library 134 according to the uploaded decryption/encryption module from the Web GUI 114. The extended library 134 includes a plurality of decryption/encryption modules such as an updated decryption/encryption module B and a defined decryption/encryption module C.

The defined module unit 128 is set in the current library 124 of the security gateway 104 and connects to the defined decryption/encryption module system of the Web GUI 114 to generate the window of the defined module unit 128 (the window is not shown here) to allow the user to fill in a field in the window with a description of the defined decryption/encryption module. The description includes an algorithm, algorithmic identifier, data encryption block size, key length, and decryption/encryption executing function. The parameters of the decryption/encryption executing function include a data address, data block size, key information, key length, initial vector, and decryption/encryption flag, etc.

When the defined module unit 128 completes the defined decryption/encryption module C, the defined decryption/encryption module C must be uploaded by the Web GUI 114 to allow the module update unit 126 to add the defined decryption/encryption module C into the extended library 134. The extended library interface 144 assists the extended library 134 in communicating with the current library 124 and the kernel 164.

The configuration unit 154, such as a system file, is used to set up the execution process according to an IPSEC protocol. When a decryption/encryption module is updated or added, the current key exchange process according to an IKE protocol is also updated as the following steps: (1) determine if the current library 124 has a default decryption/encryption module in each IKE phase 1 or 2; (2) if no, further determine if the extended library 134 has any new or updated decryption/encryption module until selecting a decryption/encryption module for the key exchange process; and (3) after the IKE completes the key exchange process, inform the kernel 164 of an update to the security argument (SA) according to the IPSEC protocol.

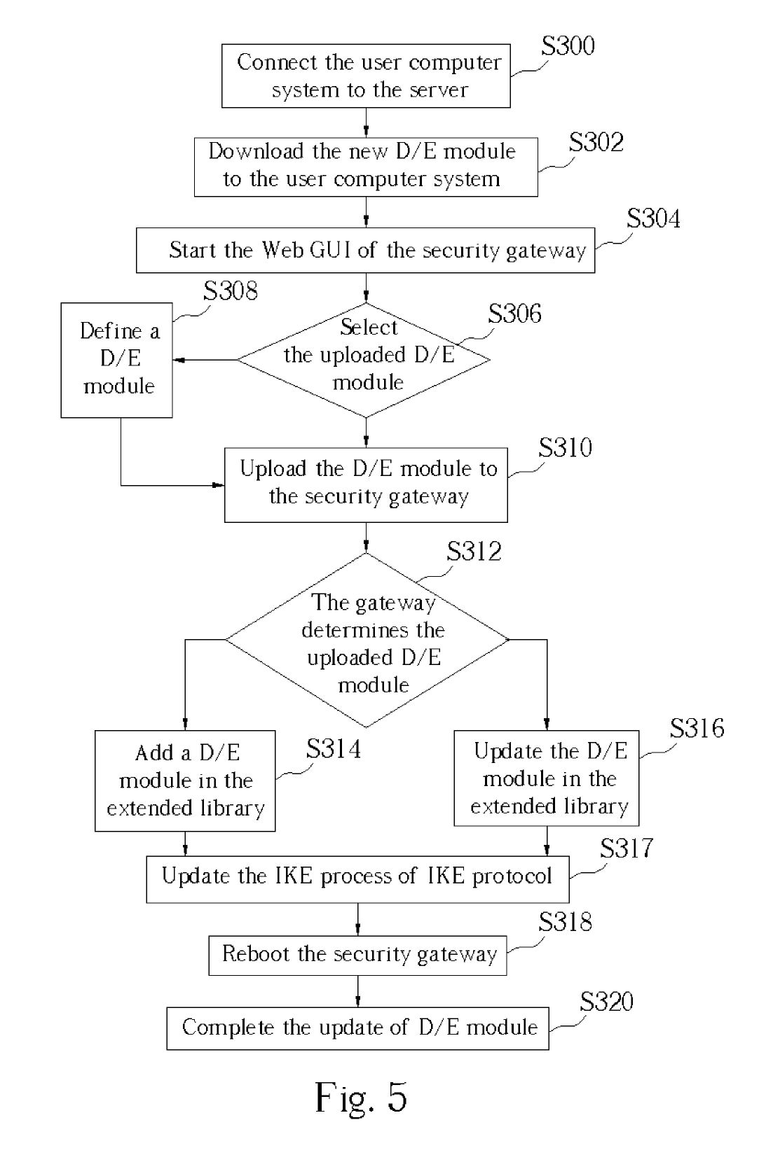

Please refer to FIG. 5. FIG. 5 is an flowchart of updating decryption/encryption modules of the security gateway according to the present invention. The steps include:

Step S300: Connect a browser of the user computer system 10 to the server 20 of the security gateway manufacturer through the Internet 50.

Step S302: Download the new decryption/encryption module to the storing device 102 of the user computer system 10.

Step S304: Start the Web GUI of the security gateway 104.

Step S306: Select the uploaded decryption/encryption module from the window provided by the Web GUI 114. If selecting the defined decryption/encryption module C, go to step S308.

Step 308: Start a window of the defined module unit 128 for providing the user with an instruction to fill in a field in the window with a description of the defined decryption/encryption module. The description includes an algorithm, algorithmic identifier, data encryption block size, key length, and decryption/encryption executing function. The parameters of the decryption/encryption executing function include a data address, data block size, key information, key length, initial vector, and decryption/encryption flag, etc. After the user determines that the parameters of decryption/encryption module C are correct, go to step S310.

Step S310: Upload the defined decryption/encryption module C to the security gateway 104.

If the updated decryption/encryption module B is selected in step S304, step S310 uploads the updated decryption/encryption module B to the security gateway 104.

Step S312: The module update unit 126 of the security gateway 104 determines that the uploaded decryption/encryption module is a defined decryption/encryption module or an updated decryption/encryption module. If the result is the updated decryption/encryption module, go to step S316. Otherwise, if the result is the defined decryption/encryption module, go to step S314.

Step S314: Add the defined decryption/encryption module into the extended library 134.

Step S316: Update the corresponding decryption/encryption module in the extended library 134.

Step S317: Update the key exchange process in the configuration set unit 154 of the security gateway 104 according to an IKE protocol. (the key change process will be described later.)

Step S318: Reboot the security gateway 104 so that the security gateway 104 can execute the updated key exchange process.

Step 320: Complete the update of the decryption/encryption module.

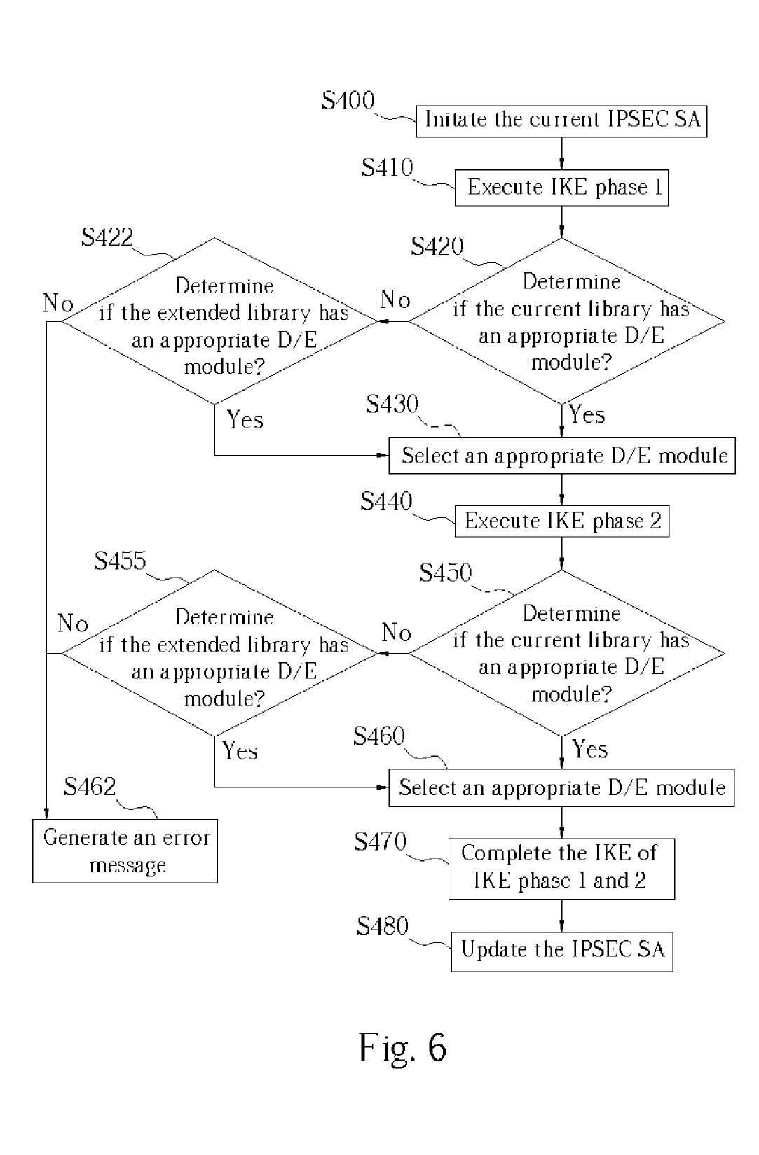

Please refer to FIG. 6. FIG. 6 is a flowchart of the updated key exchange process according to an IKE protocol in step S318. FIG. 6 applies in a previous communication of confidential transmission between a receiver and a transmitter (such as the user computer systems 10 and 30 in FIG. 1). The steps include:

Step S400: Initiate the current IPSEC SA of the security gateway 104.

Step S410: Execute an IKE phase 1.

Step S420: Determine if the current library 124 has an appropriate decryption/encryption module, such as a default decryption/encryption module. If yes, go to step S430.

Step S430: Select the key of the default decryption/encryption module and the operation logic to communicate with the receiver.

If the current library 124 does not find any acceptable decryption/encryption module in step S420, go to Step S422: Further determine if the extended library 134 has an appropriate decryption/encryption module, such as a new or updated decryption/encryption module. If yes, step S430 is processed. Then, step S430 selects the new or updated decryption/encryption module to communicate with the receiver.

Step S440: Execute an IKE phase 2.

Steps S450, S455, and S460 respectively repeat the actions of steps S420, S422 and S430. If step S422 or S455 does not find any appropriate decryption/encryption module, then step S462 is processed.

Step S462: The system generates an error message.

Step S470: Complete all the key exchange processes of IKE phases 1 and 2.

Step S480: Inform the kernel 164 of the security gateway 104 of an update to the current SA according to IPSEC protocol.

As mentioned above, the present invention allows the user of the gateway to simply update the decryption/encryption modules of the extended library of the gateway through a module update unit instead of updating the decryption/encryption modules along with the entire kernel firmware. This can reduce the setting time, increase the efficiency of operation, and reduce the maintenance cost. In addition, the present invention makes it convenient for the user to define the decryption/encryption modules through the defined module unit and the Web GUI. This promotes the expansion of decryption/encryption modules of security gateways.

Those skilled in the art will readily observe that numerous modifications and alterations of the device may be made while retaining the teachings of the invention. Accordingly, the above disclosure should be construed as limited only by the metes and bounds of the appended claims.

1. A system for actively updating a cryptography module in a security gateway, the security gateway connected between a user computer system and a network system, the system comprising:
a Web GUI for generating at least one window in the user computer system, the window having a decryption/encryption module update system to allow a user to upload a new decryption/encryption module to the security gateway by the Web GUI;
an extended library for accommodating a decryption/encryption module; and
a module update unit for actively updating a corresponding decryption/encryption module in the extended library according to the new decryption/encryption module uploaded to the security gateway or adding the uploaded decryption/encryption module into the extended library.

2. The system of claim 1 wherein the security gateway is a VPN gateway complying with an IPSEC protocol.

3. The system of claim 1 wherein the security gateway includes a current library, a kernel, and a daemon, the module update unit being located in the current library.

4. The system of claim 1 wherein the decryption/encryption module update system in the window of the Web GUI includes a system for allowing the user to update a current decryption/encryption module in the security gateway.

5. The system of claim 4 wherein the decryption/encryption module update system in the window of the Web GUI further includes a defined decryption/encryption module system for allowing the user to add a defined decryption/encryption module into the security gateway.

6. The system of claim 5 further comprising a defined module unit connected to the defined decryption/encryption module system for generating a window for providing the user with an instruction to fill in a field in the window with a description of the defined decryption/encryption module.

7. The system of claim 6 wherein the description of the defined decryption/encryption module includes an algorithm, algorithmic identifier, data encryption block size, key length, and decryption/encryption executing function, the parameters of the decryption/encryption executing function including a data address, data block size, key information, key length, initial vector, and decryption/encryption flag.

8. The system of claim 1 wherein the module update unit selects to actively update the corresponding decryption/encryption module in the extended library or to add the uploaded decryption/encryption module into the extended library according to the new decryption/encryption module.

9. The system of claim 2 further comprising an extended library interface for assisting the extended library to communicate with the current library and the kernel.

10. The system of claim 1 further comprising a configuration set unit such as a system file for setting an execution process according to an IPSEC protocol wherein after a decryption/encryption module is updated or added, the key exchange process is updated according to an IKE protocol.

11. A method for actively updating a cryptography module in a security gateway, the security gateway connected between a user computer system and a network system, the method comprising:
downloading a new decryption/encryption module to the user computer system through the network system;
starting a Web GUI of the security gateway for generating at least one window in the user computer system, the window having a decryption/encryption module update system;
selecting a decryption/encryption module from the window provided by the Web GUI;
uploading the selected decryption/encryption module to the security gateway;
a module update unit of the security gateway actively updating a corresponding decryption/encryption module in the extended library according to the uploaded decryption/encryption module or adding the uploaded decryption/encryption module into the extended library; and
updating a key exchange process in the security gateway according to an IKE protocol.

12. The method of claim 11 wherein the decryption/encryption module update system in the window of the Web GUI includes a system for allowing the user to update a current decryption/encryption module in the security gateway.

13. The method of claim 12 wherein the decryption/encryption module update system in the window of the Web GUI further includes a defined decryption/encryption module system for allowing the user to add a defined decryption/encryption module into the security gateway.

14. The method of claim 13 further comprising:
when starting the defined decryption/encryption module, generating a window for providing a user with an instruction to fill in a field in the window with a description of the defined decryption/encryption module.

15. The method of claim 14 wherein the descriptions of the defined decryption/encryption module includes an algorithm, algorithmic identifier, data encryption block size, key length, and decryption/encryption executing function, the parameters of the decryption/encryption executing function including a data address, data block size, key information, key length, initial vector, and decryption/encryption flag.

16. The method of claim 11 further comprising:
the security gateway executing the updated key exchange process.

17. A key exchange process in a security gateway according to an IKE protocol, the key exchange process comprising:
(a) initiating a current IPSEC security association (SA) of the security gateway;
(b) executing an IKE phase 1;
(c) if there is no appropriate decryption/encryption module in a current library of the security gateway, selecting an appropriate decryption/encryption module from an extended library of the security gateway;
(d) executing an IKE phase 2;
(e) repeating step (c);
(f) completing the key exchange process of the IKE phase 1 and 2; and
(g) informing the kernel of the security gateway of an update to the current IPSEC SA.
